(19) United States
(12) Patent Application Publication
(10) Pub. No.: US 2025/0043937 A1
(43) Pub. Date: Feb. 6, 2025

(54) LIGHT STRIP

(71) Applicant: MING YUNG HUNG MATERIAL OF LIGHTS CO., LTD, Jiangmen City (CN)

(72) Inventors: Xingliang CAO, Jiangmen City (CN); Jianhua DONG, Jiangmen City (CN)

(73) Assignee: MING YUNG HUNG MATERIAL OF LIGHTS CO., LTD, Jiangmen City (CN)

(21) Appl. No.: 18/372,215

(22) Filed: Sep. 25, 2023

(30) Foreign Application Priority Data
Aug. 2, 2023 (CN) 2023220667370

(51) Int. Cl. F21V 9/08; F21S 4/26; F21V 23/00

(52) U.S. Cl. CPC F21V 9/08; F21S 4/26; F21V 23/002; F21Y 2115/20

(57) ABSTRACT

A light strip is disclosed. The light strip includes a light source and a rubber sleeve accommodating the light source. The rubber sleeve includes an inner light-transmitting layer, an outer light-transmitting layer, and a color strip arranged between the inner light-transmitting layer and the outer light-transmitting layer, and the color strip and at least one of the inner light-transmitting layer and the outer light-transmitting layer are light-transmitting in different colors. The light strip provided by the present disclosure can simplify the production process, reduce the cost, and provide different lighting modes, so that the requirement is met.

### CROSS-REFERENCE TO RELATED APPLICATION

This application is filed on the basis of Chinese patent application No. 2023220667370 filed Aug. 2, 2023, and claims priority of the Chinese patent application, the entire contents of which are incorporated herein by reference.

### TECHNICAL FIELD

The present disclosure relates to a lamp structure, and in particular, to a light strip.

### BACKGROUND

Light strip is a strip-shaped flexible lamp, which can be arranged based on actual requirements to adapt to various lighting environments.

Structurally, the light strip includes a rubber sleeve and a light source positioned in the rubber sleeve. The light source may include several lamp bead strings arranged in strips, and the lamp bead string may have multiple lamp beads. The light source may also include a strip-shaped flexible circuit board and a light-emitting chip arranged on the flexible circuit board.

To provide lighting effects of various colors, variable-color lamp beads or light-emitting chips may be used, or a material of the rubber sleeve may be changed so that the rubber sleeve has different colors, to realize transmission of different lights.

However, the foregoing solutions have complicated manufacturing processes and high costs, and provide a single lighting mode, which is difficult to meet the requirements.

### SUMMARY

Embodiments of the present disclosure aims to address at least one of the technical problems in the conventional technology. Therefore, the present disclosure provides a light strip, which can simplify the production process, reduce the cost, and provide different lighting modes, so that it meets the requirement.

The light strip according to the embodiments of the present disclosure includes a light source and a rubber sleeve accommodating the light source, where the rubber sleeve includes an inner light-transmitting layer, an outer light-transmitting layer, and a color strip arranged between the inner light-transmitting layer and the outer light-transmitting layer, and the color strip and at least one of the inner light-transmitting layer and the outer light-transmitting layer are light-transmitting in different colors.

In some embodiments, the color strip is spirally wound around the inner light-transmitting layer.

In some embodiments, there are a plurality of the color strips.

In some embodiments, widths of the plurality of color strips are set differently, and/or, colors of the plurality of color strips are set differently.

In some embodiments, colors of different parts of the color strip are set differently, and/or, the color strip is provided with a pattern.

In some embodiments, the outer light-transmitting layer is arranged in a transparent mode.

In some embodiments, the inner light-transmitting layer includes a white light-transmitting layer.

In some embodiments, the inner light-transmitting layer includes a white light-transmitting layer and a transparent light-transmitting layer inside the white light-transmitting layer, the light source is arranged inside the transparent light-transmitting layer, or the inner light-transmitting layer includes a transparent light-transmitting layer, and the light source is arranged inside the transparent light-transmitting layer.

In some embodiments, the transparent light-transmitting layer includes transparent colloid and two wires embedded into the transparent colloid, and the two wires are used to supply power to the light source.

In some embodiments, a cross section of the transparent light-transmitting layer is in a shape of a ring with a notch.

The light strip according to the embodiments of the present disclosure at least has the following beneficial effects.

1. According to the present disclosure, the rubber sleeve includes the inner light-transmitting layer, the outer light-transmitting layer, and the color strip, and the color strip and at least one of the inner light-transmitting layer and the outer light-transmitting layer are light-transmitting in different colors, so that when light generated by the light source passes through the color strip, different colors of lights can be transmitted, exhibiting a lighting mode with different colors, namely multi-color lighting. Therefore, the use requirements are met.

2. According to the present disclosure, by arranging the color strip, there is no need for the light source to be a variable-color light source, or for the use of materials with various colors to form the rubber sleeve by extrusion, so that the production process can be simplified, and the manufacturing difficulty can be reduced.

3. According to the present disclosure, by arranging the color strip, a wider range of lighting modes can be provided by selecting different color strips, this allows for easier fulfillment of diverse requirements and, consequently, expands the scope of application and increases its overall value.

4. Furthermore, compared with a rubber sleeve extruded by using raw materials with various colors, the color strip has a significant color boundary line with the inner light-transmitting layer or the outer light-transmitting layer, so that the layer is clear, and the effect is more excellent.

5. According to the present disclosure, arrangement of the inner light-transmitting layer does not affect the production of the light source and the rubber sleeve, while facilitates the arrangement of the color strip. 6. According to the present disclosure, by arranging the outer light-transmitting layer, the color strip can be coated to prevent the color strip from being damaged, and to keep the light strip as an integrated structure enhancing its aesthetic appearance.

Additional aspects and advantages of the present disclosure will be set forth in part in the following description, some of which will be apparent from the following description, or will be learned by practice of the present disclosure.

### BRIEF DESCRIPTION OF DRAWINGS

The above and/or additional aspects and advantages of the present disclosure will become apparent and readily appreciated from the following description of the embodiments with reference to the accompanying drawings.

FIG. 1 is a schematic diagram of a structure of a light strip according to an embodiment of the present disclosure;

FIG. 2 is a schematic diagram of a structure of an alternative solution of the light strip in FIG. 1; and

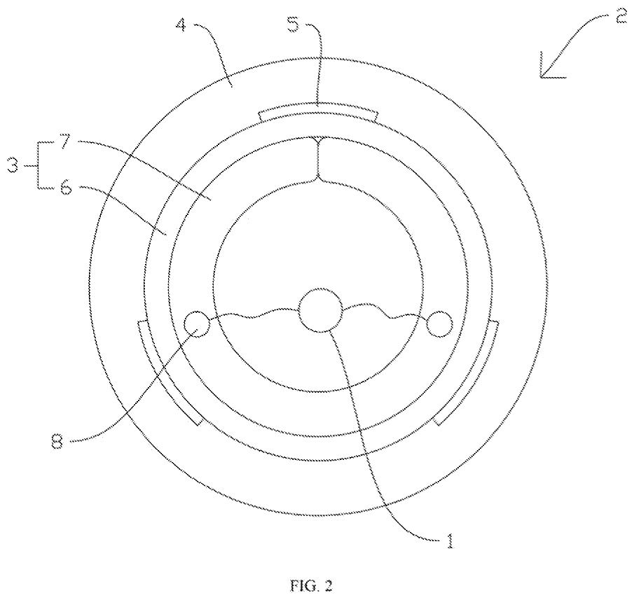

FIG. 3 is a schematic diagram of an external structure of the light strip in FIG. 1.

### REFERENCE NUMERALS

1: light source, 2: rubber sleeve, 3: inner light-transmitting layer, 4: outer light-transmitting layer, 5: color strip, 6: white light-transmitting layer, 7: transparent light-transmitting layer, and 8: wire.

### DETAILED DESCRIPTION

Embodiments of the present disclosure will be described in detail below, and examples of the embodiments are shown in the accompanying drawings, where the same or similar reference numerals indicate the same or similar elements or elements having the same or similar functions throughout.

The embodiments described below with reference to the accompanying drawings are illustrative only for the purpose of explaining the present disclosure, and are not to be construed as limiting the present disclosure.

In the description of the disclosure, it should be understood that the positional descriptions referred to, for example, the directional or positional relationships indicated by up, down, front, rear, left, right, etc., are based on the directional or positional relationships shown in the drawings, and are only for convenience and simplification of description of the disclosure, but not for indicating or implying that the referred device or element must have a specific direction, be constructed and operated in a specific direction, and thus should not be construed as limiting the disclosure.

In the description of the present disclosure, “several” means one or more, “a plurality of” means two or more, “greater than”, “less than”, “more than” and the like are understood as excluding the following number, and “above”, “below”, “within” and the like are understood as including the following number. The description of “first” and “second” is merely for the purpose of distinguishing technical features, but shall not be understood as an indication or implication of relative importance, or an implicit indication of a quantity of indicated technical features, or an implicit indication of the sequence of the indicated technical features.

In the description of the present disclosure, it should be noted that unless otherwise expressly specified and limited, terms “mount”, “interconnect”, and “connect” should be understood in a broad sense. For example, such terms may indicate a fixed connection, a detachable connection, or an integral connection; may indicate a mechanical connection or an electrical connection; and may indicate direct interconnection, indirect interconnection through an intermediate medium, or internal communication between two elements. Those of ordinary skill in the art may understand specific meanings of the foregoing terms in the present disclosure according to specific cases.

A light strip according to an embodiment of the present disclosure is described below with reference to the accompanying drawings.

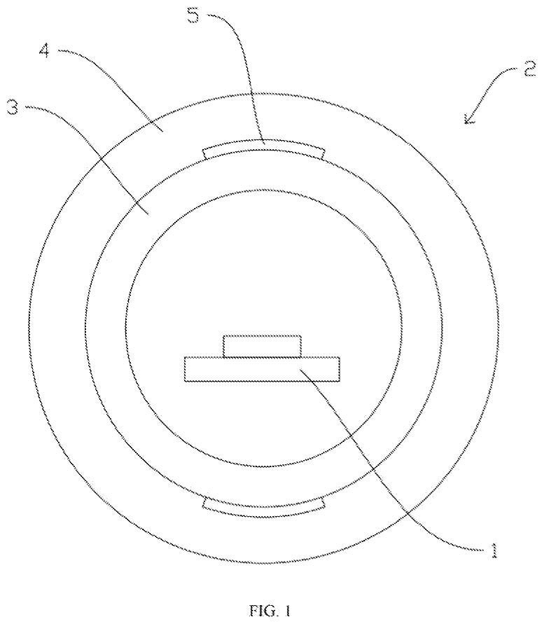

Referring to FIG. 1, the present disclosure is intended to provide an embodiment of a light strip.

In this embodiment, the light strip includes a light source 1 and a rubber sleeve 2 accommodating the light source 1.

The light source 1 may include a plurality of lamp beads, and each of the lamp beads is connected to a wire 8, thereby implementing the parallel connection of the lamp beads.

In some specific embodiments of the present disclosure, a plurality of lamp beads may be connected in a string to form a lamp bead string, and the lamp bead string is further connected to the wire 8 to implement the series connection of the lamp beads.

In some specific embodiments of the present disclosure, the light source 1 may include a plurality of lamp bead strings, and each of the lamp bead strings is connected to the wire 8 to implement the series-parallel connection of the lamp beads.

In some specific embodiments of the present disclosure, the lamp beads may be connected in series with a resistor, or, the lamp bead strings may be connected in series with a resistor; or, a resistor may be connected in series with the wire 8 to change a voltage of the lamp beads and meet the use requirements of the lamp beads.

In some specific embodiments of the present disclosure, the light source may include a light-emitting chip arranged on a circuit board.

In some specific embodiments of the present disclosure, the circuit board may be a flexible circuit board, which is convenient for arrangement.

In some specific embodiments of the present disclosure, since the lamp beads can irradiate in 360 degrees, an installation angle of the lamp beads can be ignored.

In some specific embodiments of the present disclosure, since the circuit board has a shielding effect, it is also necessary to consider a light irradiation direction during installation to meet the requirement.

In some specific embodiments of the present disclosure, the light strip may include a connector at both ends of the light strip, so as to facilitate connection to an external wire or to facilitate connection of two light strips together, so that wiring is simplified.

For the rubber sleeve 2, the rubber sleeve 2 includes an inner light-transmitting layer 3, an outer light-transmitting layer 4, and a color strip 5 arranged between the inner light-transmitting layer 3 and the outer light-transmitting layer 4, and the color strip 5 and at least one of the inner light-transmitting layer 3 and the outer light-transmitting layer 4 are light-transmitting in different colors.

In this specification, “light-transmitting in different colors” means that the colors of the transmitted light are different, i.e., the colors of the transmitted light are not completely the same, but it does not represent the light transmission quality.

In summary, firstly, in this embodiment, the rubber sleeve 2 includes the inner light-transmitting layer 3, the outer light-transmitting layer 4, and the color strip 5, and the color strip 5 and at least one of the inner light-transmitting layer 3 and the outer light-transmitting layer 4 are light-transmitting in different colors, so that when light generated by the light source 1 passes through the color strip 5, different colors of lights can be transmitted, exhibiting a lighting mode with different colors, namely multi-color lighting. Therefore, the use requirements are met.

Secondly, in this embodiment, by arranging the color strip 5, there is no need for the light source 1 to be a variable-color light source, or for the use of materials with various colors to form the rubber sleeve 2 by extrusion, so that the production process can be simplified, and the manufacturing difficulty can be reduced.

Moreover, in this embodiment, by arranging the color strip 5, a wider range of lighting modes can be provided by selecting different color strips 5. This allows for easier fulfillment of diverse requirements and, consequently, expands the scope of application and increases its overall value.

Furthermore, compared with a rubber sleeve 2 extruded by using raw materials with various colors, the color strip 5 has a significant color boundary line with the inner light-transmitting layer 3 or the outer light-transmitting layer 4, so that the layer is clear, and the effect is more excellent.

In addition, in this embodiment, arrangement of the inner light-transmitting layer 3 does not affect the production of the light source 1 and the rubber sleeve 2, while facilitates the arrangement of the color strip 5.

In addition, in this embodiment, by arranging the outer light-transmitting layer 4, the color strip 5 can be coated to prevent the color strip 5 from being damaged, and to keep the light strip as an integrated structure enhancing its aesthetic appearance.

In some specific embodiments of the present disclosure, the color strip 5 may be extended along a length direction of the rubber sleeve 2 to increase an area of the color strip 5.

In some specific embodiments of the present disclosure, the color strip 5 may be spirally wound around the inner light-transmitting layer 3, so that the color strip 5 can completely adhere to an outer surface of the inner light-transmitting layer 3, thereby reducing gaps and bubbles and providing a higher quality lighting effect.

Meanwhile, the color strip 5 is spirally wound on the inner light-transmitting layer 3, so that the color strip 5 and the inner light-transmitting layer 3 can be taken as one part, and then the outer light-transmitting layer 4 is arranged outside the inner light-transmitting layer 3 and the color strip 5 in a co-extrusion mode. Therefore, the manufacturing difficulty is reduced.

In some specific embodiments of the present disclosure, there may be a plurality of color strips 5, thereby providing more diverse and enriched lighting modes.

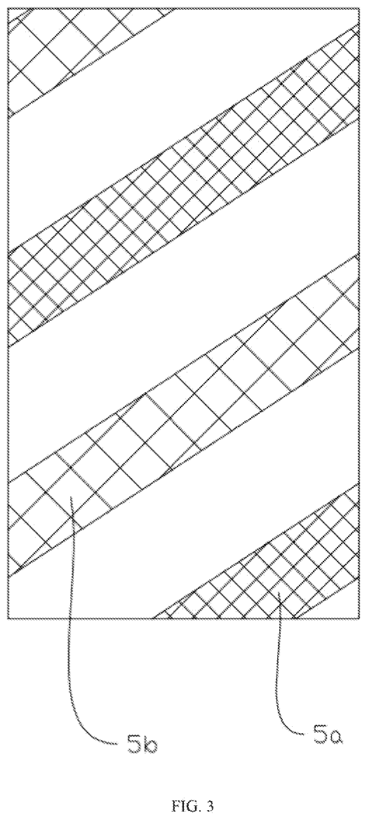

In some specific embodiments of the present disclosure, there may be two color strips 5, and the two color strips 5 are spirally wound around the inner light-transmitting layer 3, as shown in FIG. 3, such as color strip 5a and color strip 5b.

It is easily understood that, in this embodiment by arranging two color strips 5, the requirement of multi-color lighting is satisfied, and the color strips 5 are spaced sparsely and properly.

In some specific embodiments of the present disclosure, the widths of the plurality of color strips 5 may be set differently, so that the lighting ratios of various colors can be changed to meet more diverse requirements.

In some specific embodiments of the present disclosure, the colors of the plurality of color strips 5 may be set differently, for example, the colors of the color strips 5 include red, yellow, green, or the like.

In some specific embodiments of the present disclosure, the color of the color strip 5 may be a composite color, such as coexistence of red and yellow or coexistence of red and green.

In some specific embodiments of the present disclosure, the colors of different parts of the color strip 5 are set differently, so that different positions of the light strip exhibit different lighting effects, and the light strip has a wider application prospect.

In some specific embodiments of the present disclosure, the color strip 5 may be provided with a pattern or the like to meet more specific requirements of users.

In some specific embodiments of the present disclosure, the outer light-transmitting layer 4 is arranged in a transparent mode to facilitate the light transmitted through the color strip 5 to irradiate outwards.

In some specific embodiments of the present disclosure, the outer light-transmitting layer 4 may include fluorescent particles or the like to enrich the lighting pattern.

In some specific embodiments of the present disclosure, the inner light-transmitting layer 3 may include a white light-transmitting layer 6, thereby providing basic white light, avoiding direct viewing of the lamp beads or the light-emitting chip, so that the light is soft, and the dazzling light is reduced.

In some specific embodiments of the present disclosure, the inner light-transmitting layer 3 includes a white light-transmitting layer 6 and a transparent light-transmitting layer 7 inside the white light-transmitting layer 6, the light source 1 is arranged inside the transparent light-transmitting layer 7, or the inner light-transmitting layer 3 includes a transparent light-transmitting layer 7, and the light source 1 is arranged inside the transparent light-transmitting layer 7.

That is, in some specific embodiments of the present disclosure, the inner light-transmitting layer 3 may directly be the transparent light-transmitting layer 7, therefore, the color strip 5 is directly arranged on the transparent light-transmitting layer 7.

In some other specific embodiments of the present disclosure, the inner light-transmitting layer 3 may include a white light-transmitting layer 6 and a transparent light-transmitting layer 7, and the transparent light-transmitting layer 7 may be used for manufacturing the light source 1, and then the transparent light-transmitting layer 7 and the white light-transmitting layer 6 may be manufactured or assembled by co-extrusion.

In some other specific embodiments of the present disclosure, the inner light-transmitting layer 3 may include a light-transmitting layer of other colors and a transparent light-transmitting layer 7, so that the manufacturing of the light source 1 and the setting of the lighting mode are independent from each other and do not affect each other, thereby reducing the manufacturing difficulty.

In some specific embodiments of the present disclosure, the transparent light-transmitting layer 7 may include a transparent colloid and two wires 8 embedded in the transparent colloid, where the two wires 8 are used to supply power to the light source 1, so as to satisfy a condition that the light source 1 includes a lamp bead.

In some specific embodiments of the present disclosure, a cross section of the transparent light-transmitting layer 7 is in a shape of a ring with a notch, that is, the transparent light-transmitting layer 7 may be compressed, and may conveniently penetrate into the white light-transmitting layer 6 or the transparent light-transmitting layer of other colors, and may conveniently be manufactured in an assembly manner.

In some specific embodiments of the present disclosure, the cross-sectional profile of the transparent light-transmitting layer 7 may be adapted to the circuit board of the light source 1, thereby preventing the circuit board from moving freely.

In the description of the present specification, the description with reference to the terms “an embodiment”, “some embodiments”, “schematic embodiment”, “example”, “specific example”, “some examples” or the like means the particular features, structures, materials or characteristics described in combination with the embodiment or example are included in at least one embodiment or example of the present disclosure. In the present specification, the schematic expression of the above terms does not necessarily refer to the same embodiment or example. Furthermore, the particular features, structures, materials or characteristics described can be combined in any suitable manner in any one or more embodiments or examples.

The embodiments of the present disclosure have been described in detail with reference to the accompanying drawings, however, the present disclosure is not limited to the foregoing embodiments. Various changes can be made within the knowledge of those of ordinary skill in the art without departing from the gist of the present disclosure.

What is claimed is:

1. A light strip, comprising: a light source and a rubber sleeve accommodating the light source, wherein the rubber sleeve comprises an inner light-transmitting layer, an outer light-transmitting layer, and a color strip arranged between the inner light-transmitting layer and the outer light-transmitting layer, and the color strip and at least one of the inner light-transmitting layer and the outer light-transmitting layer are light-transmitting in different colors.

2. The light strip according to claim 1, wherein the color strip is spirally wound around the inner light-transmitting layer.

3. The light strip according to claim 1, wherein there are a plurality of the color strips.

4. The light strip according to claim 3, wherein widths of the plurality of color strips are set differently, and/or, colors of the plurality of color strips are set differently.

5. The light strip according to claim 1, wherein colors of different parts of the color strip are set differently, and/or, the color strip is provided with a pattern.

6. The light strip according to claim 1, wherein the outer light-transmitting layer is arranged in a transparent mode.

7. The light strip according to claim 1, wherein the inner light-transmitting layer comprises a white light-transmitting layer.

8. The light strip according to claim 1, wherein the inner light-transmitting layer comprises a white light-transmitting layer and a transparent light-transmitting layer inside the white light-transmitting layer, the light source is arranged inside the transparent light-transmitting layer, or the inner light-transmitting layer comprises a transparent light-transmitting layer, and the light source is arranged inside the transparent light-transmitting layer.

9. The light strip according to claim 8, wherein the transparent light-transmitting layer comprises transparent colloid and two wires embedded into the transparent colloid, and the two wires are used to supply power to the light source.

10. The light strip according to claim 8, wherein a cross section of the transparent light-transmitting layer is in a shape of a ring with a notch.
